(19) United States
(12) Patent Application Publication
(10) Pub. No.: US 2015/0227683 A1
(43) Pub. Date: Aug. 13, 2015

(54) METHOD TO REPRESENT THE NUCLEOTIDE ELEMENTS OF A DNA SEQUENCE AS NUMERICAL ELEMENTS TO INCLUDE CYTOSINE BEING ASSIGNED THE VALUE ONE, THYMINE BEING ASSIGNED THE VALUE TWO, ADENINE BEING ASSIGNED THE VALUE THREE, AND GUANINE BEING ASSIGNED THE VALUE FOUR

(71) Applicants: LANE BERNARD SCHEIBER, ANNANDALE, VA (US); LANE BERNAND SCHEIBER, SR., GROSSE ILE, MI (US)

(72) Inventors: LANE BERNARD SCHEIBER, ANNANDALE, VA (US); LANE BERNAND SCHEIBER, SR., GROSSE ILE, MI (US)

(21) Appl. No.: 14/176,167

(22) Filed: Feb. 10, 2014

(51) Int. Cl. G06F 19/22

(52) U.S. Cl. CPC G06F 19/22

(57) ABSTRACT

Current study of the genomes of species is conducted by examining the nucleotides as represented by the first letter of the name that has by convention been arbitrarily given to the nitrogenous base that comprises each of the four different nucleotides that comprise deoxyribonucleic acids. Representing the four nucleotides that comprise DNA by a specific number, rather than a letter, facilitates study of a numerical system and command instructions embedded in a sequence of DNA. Studying genomes by converting the nucleotides to a numerical system assists in the identification of certain genes that cannot be discovered by conventional means. The method presented consists of describing a DNA sequence by representing each cytosine with the number one, representing each thymine with the number two, representing each adenine with the number three and each guanine with the number four.

### CROSS-REFERENCE TO RELATED APPLICATIONS

None.

### STATEMENT REGARDING SPONSORED RESEARCH OR DEVELOPMENT

None.

### REFERENCE TO SEQUENCE LISTING, A TABLE, OR COMPUTER LISTING COMPACT DISC APPENDIX

Nucleotide Sequence listed as required by Code of Federal Regulations, 37 CFR Sections 1.821-1.825.

©2014 Lane B. Scheiber and Lane B. Scheiber II. A portion of the disclosure of this patent document contains material which is subject to copyright protection. The copyright owners have no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

This invention relates to any process intended to represent the nucleotide elements of DNA as numerical elements.

2. Description of Background Art

The human genome has been defined as a double stranded DNA comprised of approximately 3 billion pairs of nucleotides.

A ‘ribose’ is a five carbon or pentose sugar (C₅H₁₀O₅) present in the structural components of ribonucleic acid, riboflavin, and other nucleotides and nucleosides. A ‘deoxyribose’ is a deoxypentose (C₅H₁₀O₄) found in deoxyribonucleic acid. A ‘nucleoside’ is a compound of a sugar usually ribose or deoxyribose with a nitrogenous base by way of an N-glycosyl link. A ‘nucleotide’ is a single unit of a nucleic acid, composed of a five carbon sugar (either a ribose or a deoxyribose), a nitrogenous base and a phosphate group. There are two families of ‘nitrogenous bases’, which include: pyrimidine and purine. A ‘pyrimidine’ is a six member ring made up of carbon and nitrogen atoms; the members of the pyrimidine family include: cytosine (c), thymine (t) and uracil (u). A ‘purine’ is a five-member ring fused to a pyrimidine type ring; the members of the purine family include: adenine (a) and guanine (g). A nucleotide is usually named after the nitrogenous base comprising its structure. A ‘nucleic acid’ is a polynucleotide which is a biologic molecule such as ribonucleic acid or deoxyribonucleic acid that enable organisms to reproduce.

A ‘ribonucleic acid’ (RNA) is a linear polymer of nucleotides formed by repeated riboses linked by phosphodiester bonds between the 3-hydroxyl group of one and the 5-hydroxyl group of the next; RNAs are single stranded macromolecules comprised of a sequence of nucleotides, these nucleotides are generally referred to by their nitrogenous bases, which include: adenine, cytosine, guanine and uracil.

Deoxyribonucleic acid (DNA) is comprised of three basic elements: a deoxyribose sugar, a phosphate group and nitrogen containing bases. DNA is a macromolecule made up of two chains of repeating deoxyribose sugars linked by phosphodiester bonds between the 3-hydroxyl group of one and the 5-hydroxyl group of the next; the two chains are held antiparallel to each other by weak hydrogen bonds. DNA strands contain a sequence of four differing nucleotides generally referred to by their nitrogenous bases, which include: adenine, cytosine, guanine and thymine. Adenine is always paired with thymine of the opposite strand, and guanine is always paired with cytosine of the opposite strand; one side or strand of a DNA macromolecule is the mirror image of the opposite strand. Nuclear DNA is regarded as the medium for storing the master plan of hereditary information.

Physical characteristics of the DNA nucleotides include the following. The chemical formula for adenine is C₅H₅N₅. The adenine nucleotide has 20 total bonds, an atomic number of 70, and a molecular weight of 135.13 g/mol. The chemical formula for cytosine is C₄H₅N₃O. The cytosine nucleotide has 16 total bonds, an atomic number of 58, and a molecular weight of 111.10 g/mol. The chemical formula for guanine is C₅H₅N₅O. The guanine nucleotide has 21 bonds, an atomic number of 78, and a molecular weight of 151.13 g/mol. The chemical formula for thymine is C₅H₆N₂O₂. The thymine nucleotide has 18 bonds, an atomic number of 66, and a molecular weight of 126.11 g/mol.

Genes are generally embedded in the DNA of a species and comprise the functional aspect of DNA. Genes are considered segments of DNA that represent units of inheritance.

For purposes of study, analysis, research, reporting, storing and all other forms of communication of information regarding DNA of a species or a segment of DNA, the nucleotide elements of DNA are generally represented by abbreviating the name of the nucleotide to the first letter of the name of each nucleotide's nitrogenous base. By convention, the nucleotide ‘adenine’ is abbreviated to the letter ‘a’, the nucleotide ‘cytosine’ is abbreviated to the letter ‘c’, the nucleotide ‘guanine’ is abbreviated to the letter ‘g’ and the nucleotide ‘thymine’ is abbreviated to the letter T. The use of letters to represent the nucleotides comprising DNA is considered the state of the art for analyzing, reporting and communicating about DNA and genomes of species.

A reason why the nucleotides comprising DNA have been represented as names or abbreviated to the first letter of the names of the nitrogenous bases and not previously represented as numbers, is due to medical science community embracing Darwin's theory of evolution as the fundamental explanation for the existence of life and ultimately the existence of species' genomes. The followers of Darwin's teachings assert that life is the result a sufficient number of random events having occurred over time that the process of randomization led to organization, and eventually the construct of genes and then genomes, which resulted in the appearance of the various species of life that have inhabited the earth. Since the greater medical science community believes life is the result of an elaborate series of random events, there has been no incentive, until the art presented here, to seek out an organizational pattern regarding the design of the human genome or any species' genome either individually or collectively. Further, the nucleotides comprising DNA have been represented by names or letters and not previously been converted to numerical values has been that since the existence of the genomes has been considered to be due to a random circumstances there has been no effort to investigate for (1) instructions that would be necessary to direct the construction of complex molecules such as proteins comprised of multiple differing chains or proteins combined with other substances such as lipids, and (2) command and control means to act as directives to facilitate organized functions as would be required if a predesigned structured system were to exist in a cell.

Representing DNA or a species' genome using letters to represent nucleotides does not facilitate study of DNA for purposes of locating numbers that act as unique identifiers embedded in DNA. This art asserts that a unique identifier is a segment of nucleotides that is uniquely associated with a specific segment of DNA. A unique identifier acts as the means for the cell to locate a segment of DNA when required. The segment of DNA that the unique identifier is associated with may either be a segment of transcribable DNA or a segment of DNA that is not transcribable, such as embedded text.

A gene is generally considered to represent a segment of DNA that is transcribable. When transcribed, a gene may produce a variety of one or more RNAs including messenger RNA(s), transport RNA(s), ribosomal RNA(s), and small molecule RNA(s).

This art asserts genes are divided into two major functional activation groups. A gene is either an ‘executable gene’ or a ‘follower gene’. An executable gene has a unique identifier associated with it to facilitate the transcription mechanisms to properly locate the gene when transcription of the gene is required. Follower genes are automatically transcribed once the executable gene, that the follower gene or genes are associated with, has been transcribed.

The ‘transcription complex’, also referred to as the ‘transcription mechanism’, is reported to be comprised of over forty separate proteins that assemble together to ultimately function in a concerted effort to transcribe the nucleotide sequence of DNA into RNA. The transcription complex (TC) may include elements such as ‘general transcription factor Sp1’, ‘general transcription factor NF1’, ‘general transcription factor TATA-binding protein’, TF_{II}D′, ‘basal transcription complex’, and a ‘RNA polymerase protein’ to name only a few of the forty elements that may combine to form a functional transcription complex. The elements of the transcription complex function as (1) a means to recognize the location of the start of a gene, (2) as proteins to bind the transcription complex to DNA such that transcription may occur or (3) as means of transcribing DNA nucleotide coding to produce a precursor RNA molecule or molecules. There are at least three different RNA polymerase proteins which include: RNA polymerase I, RNA polymerase II, and RNA polymerase III. RNA polymerase I tends to be dedicated to transcribing genetic information that will result in the formation of ribosomal RNA molecules. RNA polymerase II tends to be dedicated to transcribing genetic information that will result in the formation of messenger RNA molecules. RNA polymerase III appears to be dedicated to transcribing genetic information that results in the formation of transport RNA molecules, small molecule RNAs and viral RNAs. The transcription complex that combines with one of the three differing RNA polymerase molecules attaches to DNA in differing sites local to the transcription start site (TSS) depending upon the type of RNA product that is expected to result once the gene has been transcribed.

This art asserts a unique identifier is generally a segment of 25 nucleotides embedded in DNA. Given transcription factors attach to transcribable genes in different configurations depending upon whether the RNA polymerase molecule of the transcription complex is RNA polymerase I, or RNA polymerase II, or RNA polymerase III, the unique identifier may be comprised of 25 nucleotides represented in a single unbroken segment of DNA or a unique identifier may be divided into two or more smaller segments of DNA. A unique identifier facilitates the cell transcription machinery in locating a specific executable gene present in a genome when transcription of the executable gene is required.

A unique identifier for three differing viral genomes has been defined.

Human immunodeficiency virus 1 (HXB2), complete genome; HIV1/HTLV-III/LAV reference genome, GenBank K03455.1. (Accessed Oct. 20, 2013 at http://www.ncbi.nlm.nih.gov/nuccore/1906382.) The human immunodeficiency virus (HIV) type 1 HXB2 DNA genome at position 431 to 455 has the twenty-five nucleotide sequence (SEQ ID NO: 1) 5′-agcagctgctttttgcctgtactgg-3′, as a unique sequence located between HIV's TATA box and the TSS and is referred to as the unique identifier of HIV. This twenty-five nucleotide sequence does not appear naturally in the uninfected human genome.

Herpes simplex virus 1, complete genome, NCBI Reference sequence: NC_{—}001806.1. (Accessed Oct. 20, 2013 at http://www.ncbi.nlm.nih.gov/nuccore/9629378?report=genbank.) The herpes simplex type 1 virus (HSV-1) envelope glycoprotein C (gC) gene has a TATA box is located at −30 position from the TSS, leaving 26 nucleotides to exist between the TATA box and the TSS for this HSV gene. The twenty-five nucleotide sequence that exists between the TATA box and the TSS is at position 96,145 to 96,169 and is (SEQ ID NO: 2) 5′-aattccggaaggggacacgggctac-3′. This unique identifier of the HSV-1 gC gene is not found in the uninfected human genome.

Human Herpesvirus 3 (Varicella-zoster virus), complete genome, NCBI Reference Sequence: NC_{—}001348.1. (Accessed Oct. 20, 2013 at http://www.ncbi.nlm.nih.gov/nuccore/9625875?report=genbank.) The varicella-zoster virus (VZV) has a unique identifier located between the TATA box and the transcription of the OR21 gene. The twenty-five nucleotide sequence representing the unique identifier for the OR12-VZV gene is positioned at 30,734 to 30,758 and is (SEQ ID NO: 3) 5′-aagttaagtcagcgtagaatatacc-3′. The twenty-five nucleotide sequence for the OR21-VZV gene is not found in the naturally occurring in the uninfected human genome.

Some variances occur regarding the unique identifiers due to species differentiation and random mutations involving DNA from species to species and/or mutations from individual life form to individual life form.

The concept of utilizing a specific numerical cipher to convert individual nucleotides' name or letter, comprising a segment of DNA, to specific numbers is a method that has not been appreciated or realized in prior art.

### BRIEF SUMMARY OF THE INVENTION

The current state of the art is to represent the nucleotide elements of DNA using the first letter of the name of the nucleotide. This art asserts representing the nucleotide elements of DNA in a numerical format, which is a novel departure from and a significant advancement over the current state of the art.

The brief description of the invention is the method where a DNA sequence is described by representing the nucleotide element or elements of cytosine as the numerical value of one, representing the nucleotide element or elements of thymine as the numerical value of two, representing the nucleotide element or elements of adenine as the numerical value of three, and representing the nucleotide element or elements of guanine as the numerical value of four.

The representation of the nucleotides of a DNA sequence as numerical values facilitates study of DNA for the purpose of research to generate medical and agricultural therapies not yet realized or appreciated as discoverable.

### DETAILED DESCRIPTION

This art asserts that the programming code comprising the DNA genome of most of the species that have inhabited the planet was not the result of random events, but that instead, the construct of DNA genomes and that the arrangement of DNA genomes were designed and was intentional. Further, the numerical organizational system comprising DNA genomes is identifiable and definable.

In the context of DNA sequences or DNA genomes of species the conversion of the ‘adenine’ nucleotides generally represented by the letter ‘a’, the ‘guanine’ nucleotides generally represented by the letter ‘g’, the ‘cytosine’ nucleotides generally represented by the letter ‘c’ and the ‘thymine’ nucleotides generally represented by the letter ‘t’, to an array of numeric values has not previously been demonstrated in the medical literature for purposes of study, analysis, research, reporting, storing and all other forms of communication of information regarding a segment of DNA or species' genome.

Converting the letters that represent nucleotides to numerical values suggests that there are twenty-four possible combinations that could be utilized as a cipher if each adenine nucleotide were assigned the same unique numerical value and each individual cytosine nucleotide were assigned the same unique numerical value and each individual guanine nucleotide were assigned the same unique numerical value and each individual thymine nucleotide were assigned the same unique numerical value.

The twenty-four possible combinations of the four nucleotides that comprise DNA include: (1) acgt, (2) actg, (3) agct, (4) agtc, (5) atcg, (6) atgc, (7) cagt, (8) catg, (9) cgat, (10) cgta, (11) ctag, (12) ctga, (13) gact, (14) gatc, (15) gcat, (16) gcta, (17) gtac, (18) gtca, (19) tacg, (20) tagc, (21) tcag, (22) tcga, (23) tgac, and (24) tgca.

An infinite number of four-number numerical combinations could be used as assignments to the literal nucleotide elements of DNA if all possible numerical series were considered. Assigning a specific numerical value to represent a specific nucleotide may be considered an arbitrary choice. The number series ‘0, 1, 2, 3’ (0-3) conserves the possibility that mathematical equations or mathematical progressions may be represented in DNA and thus become definable once interpretation of DNA with such a cipher is undertaken.

Assigning the number series 0, 1, 2, 3 to the twenty-four possible combinations of the four nucleotides that comprise DNA include: (1) a=0, c=1, g=2, t=3; (2) a=0, c=1, t=2, g=3; (3) a=0, g=1, c=2, t=3; (4) a=0, g=1, t=2, c=3; (5) a=0, t=1, c=2, g=3; (6) a=0, t=1, g=2, c=3; (7) c=0, a=1, g=2, t=3; (8) c=0, a=1, t=2, g=3; (9) c=0, g=1, a=2, t=3; (10) c=0, g=1, t=2, a=3; (11) c=0, t=1, a=2, g=3; (12) c=0, t=1, g=2, a=3; (13) g=0, a=1, c=2, t=3; (14) g=0, a=1, t=2, c=3; (15) g=0, c=1, a=2, t=3; (16) g=0, c=1, t=2, a=3; (17) g=0, t=1, a=2, c=3; (18) g=0, t=1, c=2, a=3; (19) t=0, a=1, c=2, g=3; (20) t=0, a=1, g=2, c=3; (21) t=0, c=1, a=2, g=3; (22) t=0, c=1, g=2, a=3; (23) t=0, g=1, a=2, c=3; and (24) t=0, g=1, c=2, a=3.

In the art as presented for the purposes of research and study, a cipher functions in two distinct manners for those skilled in the art of genetics research and genetics engineering. First, a cipher acts as a mathematical translation to convert names/letters of DNA nucleotides to a number series to facilitate mathematical study of the DNA to discover mathematical equations or mathematical progressions present in the DNA. Second, a cipher acts as a means to facilitate visual pattern recognition by the human eye. The human eye may see patterns embedded in series of numbers that are not as well discovered if the elements are represented solely as names of nucleotides or letters. Some researchers may find it difficult to conceptualize a numerical series that starts with a ‘zero’ being assigned to four differing nucleotide elements and therefore said researches may find it difficult to utilize such a number series to perform pattern recognition when studying DNA sequences. Said researchers may prefer to study the DNA with a cipher comprised of a number series made up of ‘1, 2, 3, 4’ because such a series offers an easier to understand and visually more appealing number series to work with when studying DNA sequences. Based on visual appeal, the number series 1, 2, 3, 4 is chosen as the number series to assign numbers to the names/letters of DNA nucleotides.

Assigning the number series 1, 2, 3, 4 to the twenty-four possible combinations of the four nucleotides that comprise DNA include: (1) a=1, c=2, g=3, t=4; (2) a=1, c=2, t=3, g=4; (3) a=1, g=2, c=3, t=4; (4) a=1, g=2, t=3, c=4; (5) a=1, t=2, c=3, g=4; (6) a=1, t=2, g=3, c=4; (7) c=1, a=2, g=3, t=4; (8) c=1, a=2, t=3, g=4; (9) c=1, g=2, a=3, t=4; (10) c=1, g=2, t=3, a=4; (11) c=1, t=2, a=3, g=4; (12) c=1, t=2, g=3, a=4; (13) g=1, a=2, c=3, t=4; (14) g=1, a=2, t=3, c=4; (15) g=1, c=2, a=3, t=4; (16) g=1, c=2, t=3, a=4; (17) g=1, t=2, a=3, c=4; (18) g=1, t=2, c=3, a=4; (19) t=1, a=2, c=3, g=4; (20) t=1, a=2, g=3, c=4; (21) t=1, c=2, a=3, g=4; (22) t=1, c=2, g=3, a=4; (23) t=1, g=2, a=3, c=4; and (24) t=1, g=2, c=3, a=4.

Comparing the physical characteristics of total bonds, total atomic number and total molecular weight of the four nucleotides, reveals order amongst the four DNA nucleotides.

Total bonds of a nucleotide refers to the total number of bonds between each atom comprising the molecule. Total number of bonds in a cytosine nucleotide (C₄H₅N₃O) is 16. Total number of bonds in a thymine nucleotide (C₅H₆N₂O₂) is 18. Total number of bonds in an adenine nucleotide (C₅H₅N₅) is 20. Total number of bonds in a guanine nucleotide (C₅H₅N₅O) is 21.

Total atomic number of a nucleotide refers to the total of the atomic numbers of each atom comprising the molecule. The total atomic number of cytosine nucleotide is 58. The total atomic number of a thymine nucleotide is 66. The total atomic number of an adenine nucleotide is 70. The total atomic number of a guanine nucleotide is 78.

Total molecular weight of a nucleotide refers to the total of the molecular weight of each atom comprising the molecule. The total molecular weight of cytosine nucleotide is 111.10 g/mol. The total molecular weight of a thymine nucleotide is 126.11 g/mol. The total atomic weight of an adenine nucleotide is 135.13 g/mol. The total atomic weight of a guanine nucleotide is 151.13 g/mol.

By comparing the three physical characteristics of the total bonds, the total atomic number and the total molecular weight for the four nucleotides, all three physical characteristics reveal an arrangement of the nucleotides in the same order. The four nucleotides rank from smallest to largest in the order of cytosine being the smallest, thymine being the next largest, adenine being the third largest, and guanine being the largest.

Of the twenty-four possible numerical combinations to assign to the nucleotide elements of the DNA, the nucleotides are assigned a numerical value derived by comparing the physical characteristics of total bonds, total atomic number and total molecular weight between the four nucleotides. As a result of the comparison of physical characteristics of the four DNA nucleotides and utilizing the 1, 2, 3, 4 number series, the nucleotide ‘cytosine’, being the smallest, is assigned the numerical value of ‘one’, the nucleotide ‘thymine’, being the next largest, is assigned the numerical value of ‘two’, the nucleotide ‘adenine’, being the third largest, is assigned the numerical value of ‘three’, and the nucleotide ‘guanine’ being the largest, is assigned the numerical value of ‘four’.

Unique identifiers may be present upstream or downstream from a gene's transcriptions start site, depending upon the construct of the transcription complex utilized to transcribe the genetic information. At least three DNA viruses have at least one unique identifier. Human immunodeficiency virus 1 (HXB2), complete genome; HIV1/HTLV-III/LAV reference genome, GenBank K03455.1. (Accessed Oct. 20, 2013 at http://www.ncbi.nlm.nih.gov/nuccore/1906382.) The human immunodeficiency virus type 1 (HXB2) has a unique 25-character identifier at 431-455, which is (SEQ ID NO: 1) 5′-agcagctgctttttgcctgtactgg-3′, that is not found in the human genome. Using the cipher whereby c=1, t=2, a=3, and g=4 (ctag) the unique identifier for HIV can be converted to the quaternary numerical representation of 5′-3413412412222241124231244-3′.

Herpes simplex virus 1, complete genome, NCBI Reference sequence: NC_{—}001806.1. (Accessed Oct. 20, 2013 at http://www.ncbi.nlm.nih.gov/nuccore/9629378?report=genbank.) In the herpes simplex virus 1 genome the critical envelope glycoprotein c gene at 96,145-96,169, the unique identifier not found in the human genome is (SEQ ID NO: 2) 5′-aattccggaaggggacacgggctac-3′. Using the cipher whereby c=1, t=2, a=3, and g=4 (ctag) the unique identifier for the herpes simplex virus 1 genome critical envelope glycoprotein c gene can be converted to the quaternary numerical representation of 5′-3322114433444431314441231-3′.

Human Herpesvirus 3 (Varicella-zoster virus), complete genome, NCBI Reference Sequence: NC_{—}001348.1. (Accessed Oct. 20, 2013 at http://www.ncbi.nlm.nih.gov/nuccore/9625875?report=genbank.) In the varicella zoster virus genome the vital ORF21 gene at 30,734-30,758, the unique identifier not found in the human genome is (SEQ ID NO: 3) 5′-aagttaagtcagcgtagaatatacc-3′. Using the cipher whereby c=1, t=2, a=3, and g=4 (ctag) the unique identifier for the varicella zoster virus genome the vital ORF21 gene can be converted to the quaternary numerical representation of 5′-3342233421341423433232311-3′.

Future nuclear binding proteins designed to seek out and engage the unique identifier of a virus embedded in the human genome will deactivate DNA embedded viruses, permanently preventing such a virus from replicating. Nuclear binding proteins designed to activate or deactivate key executable genes by seeking out and engaging unique identifiers will provide future pharmaceutical targets to manage challenging medical problems including diabetes and osteoarthritis.

The Prime Genome words and image are represented in U. S. Trademark Reg. No. 4,267,719. The Prime Genome represents the art whereby each individual species' DNA genome of all of the species that have inhabited the earth can trace the lineage of their species' genome back to a single original master genome. Analysis of the genomes of like species demonstrates that genes are shared amongst like species. Often, like genes are shared amongst unlikely species. It has been estimated that the human genome shares 45% of its genome with the genome of a banana. Representing the human genome's nucleotides as numerical values, facilitates the determination of sets of numbers that correspond to groupings of genes. The three unique identifiers previously identified for the three virus genomes HIV, HSV and VZV all start with the number ‘THREE’ as the first character of the unique identifier, which will facilitate the identification of other viral unique identifiers of like viral genomes.

It is generally believed that the human genome, comprised of 3 billion pairs of nucleotides, is currently considered to be composed of 5% genetic material and 95% of genetic junk, or more specifically 95% of the human genome represents meaningless genetic material. Genes are currently identified by the proteins that are generated when the gene is transcribed. Command instructions are generally not known and but must exist to facilitate the proper construction of organelles, cells, tissues, organs, and the overall construct of the body of a particular species. Command instructions do not produce proteins when transcribed, therefore cannot be identified by conventional research tools that depend upon protein production as the means to identify the existence of a gene. Representing nucleotides of genomes as numbers and deciphering unique identifiers for genes comprising the human genome and the genome of other species, facilitates the means to identify the locations in a species' genome where command instructions exist that dictate how complex proteins are constructed and how simple proteins and complex proteins are arranged to form organelles, cells, tissues, organs, and the overall construct of the body.

It is logical that that unique numbering systems would represent sets of genes associated with the construct of organelles, and that differing number systems would be associated with sets of genes to construct the various types of cells, and that differing number systems would be associated with sets of genes to construct the various types of organs, and that differing number systems would be associated with sets of genes to construct the physical body as a whole for various species.

By utilizing the process to convert the nucleotides comprising DNA to numerical values, additional research will be able to identify and define the biologic instructions responsible for the construct of organelles, cells, tissues, organs, and the body as a whole for species. Identifying of the command instructions in the human genome and the genome of other animal species and plant species and viruses and bacteria and parasites will lead to a broader field of pharmaceutical agents to successfully treat and manage disease states both in humans and agriculture.

### CONCLUSIONS, RAMIFICATION, AND SCOPE

Accordingly, the reader will see that the process to represent the nucleotides comprising the species genomes as numerical values represents a new and unique state of the art that has never before been recognized nor appreciated by those skilled in the art.

Although the description above contains specificities, these should not be construed as limiting the scope of the invention but as merely providing illustrations of some of the presently preferred embodiments of the invention.

The terms and expressions which are employed here are used as terms of description and are not of limitation and there is no intention, in the use of terms and expressions, of excluding equivalents of the features presented, and described, or portions thereof, it being recognized that various modifications are possible in the scope of the invention or process as claimed.

What is claimed:

1. A method for describing a plurality of cytosine nucleotides, a plurality of thymine nucleotides, a plurality of adenine nucleotides, a plurality of guanine nucleotides of a deoxyribonucleic acid sequence comprising:
(a) representing each said cytosine nucleotide as numerical value of one,
(b) representing each said thymine nucleotide as numerical value of two,
(c) representing each said adenine nucleotide as numerical value of three, and
(d) representing each said guanine nucleotide as numerical value of four,
whereby said representation of said nucleotides comprising said deoxyribonucleic acid sequence as numerical values facilitates defining of a numerical system which uniquely identifies a plurality of genes comprising said deoxyribonucleic acid sequence for the purpose of expanding current art of genetics beyond discovery of said genes solely responsible for protein production to include said genes responsible for generating command instructions in the form of ribonucleic acids.


SEQUENCE LISTING (3 sequences)

SEQ ID NO: 1 - DNA, 25 bp, Human immunodeficiency virus type 1
agcagctgctttttgcctgtactgg

SEQ ID NO: 2 - DNA, 25 bp, Herpes simplex virus 1
aattccggaaggggacacgggctac

SEQ ID NO: 3 - DNA, 25 bp, Varicella zoster
aagttaagtcagcgtagaatatacc